(19) United States
(12) Patent Application Publication
(10) Pub. No.: US 2009/0297937 A1
(43) Pub. Date: Dec. 3, 2009

(54) Lithium-ion secondary battery

(76) Inventors: Christina M. Lampe-Onnerud, Framingham, MA (US); Per Onnerud, Framingham, MA (US); Yanning Song, Chelmsford, MA (US); Richard V. Chamberlain, II, Fairfax Station, VA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/386,266

(22) Filed: Apr. 15, 2009

Related U.S. Application Data
(60) Provisional application No. 61/208,443, filed on Feb. 24, 2009.
(60) Provisional application No. 61/125,285, filed on Apr. 24, 2008.

(51) Int. Cl. H01M 4/48; H01M 4/82; H01M 6/42

(52) U.S. Cl. 429/156; 429/231.3; 429/224; 429/223; 29/623.1

(57) ABSTRACT

A lithium-ion battery comprises a cathode that includes an active cathode material. The active cathode material comprises a cathode mixture that includes a lithium cobaltate and a spinel type lithium manganate, wherein the lithium cobaltate and the lithium manganate are in a weight ratio of lithium cobaltate:lithium manganate between about 0.95:0.05 to about 0.55:0.45, and wherein a ratio of the mean particle diameter of the lithium cobaltate to the mean particle diameter of the lithium manganate is in a range of between about 1:0.35 and about 1:1.4.

### RELATED APPLICATIONS

This application claims the benefit of U.S. Provisional Application No. 61/208,443, filed on Feb. 24, 2009 and U.S. Provisional Application No. 61/125,285, filed Apr. 24, 2008. The entire teachings of the above applications are incorporated herein by reference.

### BACKGROUND OF THE INVENTION

Rechargeable batteries, such as lithium-ion rechargeable batteries, are widely used as electrical power for battery-powered portable electronic devices, such as cellular telephones, portable computers, camcorders, digital cameras, PDAs and the like. A typical lithium-ion battery pack for such portable electronic devices employs multiple cells that are configured in parallel and in series. For example, a lithium-ion battery pack may include several blocks connected in series where each block includes one or more cells connected in parallel. Each block typically has an electronic control that monitors voltage levels of the block. In an ideal configuration, each of the cells included in the battery pack is identical. However, when cells are aged and cycled, they tend to deviate from the initial ideal conditions, resulting in an unbalanced cell pack (e.g., unidentical capacity, impedance, discharge and charge rate). This unbalance among the cells may cause over-charge or over-discharge during normal operation of the rechargeable batteries, and in turn can impose safety concerns, such as explosion (i.e., rapid gas release and possibility for fire).

Typically, lithium-ion rechargeable batteries employ solely LiCoO₂-type materials as the active component of lithium-ion battery cathodes. For such a lithium-ion cell employing solely LiCoO₂-type active cathode materials to be fully charged, the charge voltage is usually 4.20V. With lower charging voltage, the capacity is lower, which corresponds to lower utilization of active LiCoO₂ materials. On the other hand, with higher charging voltage, the cell is less safe. In general, it is a challenge for LiCoO₂-based lithium-ion cells to have a high capacity, for example higher than about 3 Ah, due to safety concerns. Lowering charge voltage is one option to maximize safety. However, this will lower the cell capacity, and in turn lower cell energy density. To obtain higher capacity, increasing the number of cells in one battery pack may be another alternative to increasing the charge voltage. However, an increase in the number of cells can result in increased probability of unbalance among the cells, which can cause over-charge or over-discharge during normal operation, as discussed above.

The largest mainstream cell that is typically used in the industry currently is a so-called “18650” cell. This cell has an outer diameter of about 18 mm and a length of 65 mm. Typically, the 18650 cell utilizes LiCoO₂ and has a capacity between 1800 mAh and 2400 mAh but cells as high as 2600 mAh are currently being used. It is generally believed that it is not safe to use LiCoO₂ in a cell larger than the 18650 cell because of safety concerns associated with LiCoO₂. Other cells larger than the 18650 cells exist in the art, for example, “26650” cells having an outer diameter of about 26 mm and a length of 65 mm. 26650 cells typically do not contain LiCoO₂ and have poorer performance characteristics in terms of Wh/kg and Wh/L than do 18650 cells employing LiCoO₂.

Therefore, there is a need to develop new active cathode materials for lithium-ion batteries that minimize or overcome the above-mentioned problems. In particular, there is a need to develop new active cathode materials that can enable manufacture of large batteries, for example, batteries larger than the conventional LiCoO₂-based batteries (e.g., 18650 cells) in volume and/or Ah/cell.

### SUMMARY OF THE INVENTION

The present invention is generally directed to (1) an active cathode material that includes a mixture of a lithium cobaltate and a spinel type lithium manganate, (2) a lithium-ion battery having such an active cathode material, (3) a method of forming such a lithium-ion battery, (4) a battery pack comprising one or more cells, each of the cells including such an active cathode material, and (5) a system that includes such a battery pack or lithium-ion battery, and a portable electronic device.

In the invention, the active cathode material includes a cathode mixture that includes a lithium cobaltate and a spinel type lithium manganate, wherein the lithium cobaltate and the lithium manganate are in a weight ratio of lithium cobaltate:lithium manganate between about 0.95:0.05 and about 0.55:0.45, and wherein a ratio of the mean particle diameter of the lithium cobaltate to the mean particle diameter of the lithium manganate is in a range of between about 1:0.35 and about 1:1.4.

The present invention can be used in mobile electronic devices such as portable computers, cell phones and portable power tools. The present invention can also be used in batteries for hybrid electric vehicles.

### BRIEF DESCRIPTION OF THE DRAWINGS

FIG. 1 is a schematic view of a prismatic battery of the invention.

FIG. 2A shows a top view of the prismatic battery of FIG. 1.

FIG. 2B shows a side view of the lid of the prismatic battery of FIG. 1.

FIG. 3 shows a schematic view of a cylindrical battery of the invention.

FIG. 4 is a schematic circuitry showing how individual cells in the invention are preferably connected when arranged together in a battery pack of the invention.

### DETAILED DESCRIPTION OF THE INVENTION

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

In one embodiment, the present invention relates to an active cathode material mixture that can be employed in an electrode of a lithium-ion battery that allows lithium to be reversibly intercalated and extracted. The active cathode material comprises a mixture that includes a lithium cobaltate and a spinel type lithium manganate (“lithium manganate spinel”). Generally, the lithium cobaltate and the lithium manganate spinel are in a weight ratio of lithium cobaltate:lithium manganate spinel between about 0.95:0.05 and about 0.55:0.45. In a specific embodiment, the lithium cobaltate and the lithium manganate spinel are in a weight ratio of lithium cobaltate:lithium manganate spinel between about 0.95:0.05 and about 0.65:0.35. In another specific embodiment, the lithium cobaltate and the lithium manganate spinel are in a weight ratio of lithium cobaltate:lithium manganate spinel between about 0.95:0.05 and about 0.7:0.3. In another specific embodiment, the lithium cobaltate and the lithium manganate spinel are in a weight ratio of lithium cobaltate:lithium manganate spinel between about 0.85:0.15 and about 0.75:0.25. In another specific embodiment, the mixture includes about 80 wt % of the lithium cobaltate and about 20 wt % of the lithium manganate spinel.

Typically, a ratio of the mean particle diameter of the lithium cobaltate to the mean particle diameter of the lithium manganate spinel is in a range of between about 1:0.35 and about 1:1.4. As used herein, a “mean particle diameter” typically is determined by averaging the maximum and minimum axes of individual particles appearing in a scanning electron microscope (SEM) examination field, typically encompassing several hundred particles. Each particle's average axis is then averaged over the entire field, thus calculating the “mean particle diameter.” Commercial software packages, for example, Olympus-SIS Platinum, can be utilized to perform the measurements and calculations resulting in the mean particle diameter.

In a specific embodiment, the ratio of the mean particle diameter of the lithium cobaltate to the mean particle diameter of the lithium manganate spinel is in a range of between about 1:0.35 and about 1:1.4. In another specific embodiment, the ratio of the mean particle diameter of the lithium cobaltate to the mean particle diameter of the lithium manganate spinel is in a range of between about 1:0.4 and about 1:1.2.

In yet another specific embodiment, the mean particle diameter of the lithium cobaltate is greater than the mean particle diameter of the lithium manganate spinel. For example, the ratio of the mean particle diameter of the lithium cobaltate to the mean particle diameter of the lithium manganate spinel is in a range of between about 1:0.5 and about 1:0.9, between about 1:0.6 and about 1:0.9, or between about 1:0.6 and about 1:0.8 (e.g., about 1:0.7, about 1:0.73, about 1:0.75, about 1:0.78, or about 1:0.8).

Typically, the mean particle diameter of the lithium cobaltate is in a range between about 1 micron and about 20 microns. In a specific embodiment, the mean particle diameter of the lithium cobaltate is in a range between about 1 micron and about 10 microns. In another specific embodiment, the mean particle diameter of the lithium cobaltate is in a range between about 3 microns and about 8 microns. In yet another specific embodiment, the mean particle diameter of the lithium cobaltate is in a range between about 4 microns and about 8 microns (e.g., about 6 microns).

Typically, the mean particle diameter of the lithium manganate spinel is in a range between about 1 micron and about 20 microns. In a specific embodiment, the mean particle diameter of the lithium manganate spinel is in a range between about 1 micron and about 10 microns. In another specific embodiment, the mean particle diameter of the lithium manganate spinel is in a range between about 3 microns and about 8 microns. In yet another specific embodiment, the mean particle diameter of the lithium manganate spinel is in a range between about 3 microns and about 6 microns (e.g., about 4 microns).

Suitable examples of lithium cobaltates that can be employed in the invention include LiCoO₂ that is optionally modified by at least one of modifiers of Li and Co atoms. Examples of the Li modifiers include barium (Ba), magnesium (Mg), calcium (Ca), strontium (Sr) and sodium (Na). Examples of the Co modifiers include the modifiers for Li and aluminum (Al), manganese (Mn) and boron (B). Other examples include nickel (Ni) and titanium (Ti).

One type of the lithium cobaltates that can be employed in the invention is represented by an empirical formula of Liₓ₆M′_{y6}Co_{(1-z6)}M″_{z6}O₂, wherein x6 is greater than 0 and less than 1.2; y6 is greater than 0 and less than 0.1, z6 is equal to or greater than 0 and less than 0.5; M′ is at least one member of magnesium (Mg) and sodium (Na) and M″ is at least one member of the group consisting of manganese (Mn), aluminum (Al), boron (B), titanium (Ti), magnesium (Mg), calcium (Ca) and strontium (Sr), can be used in the invention.

Another type of the lithium cobaltates that can be employed in the invention is represented by an empirical formula of Li₍₁₊ₓ₈₎CoO_{z8}, wherein x8 is equal to or greater than zero and equal to or less than 0.2, and wherein z8 is equal to or greater than 1.9 and equal to or less than 2.1. A common example is LiCoO₂ optionally coated with ZrO₂ or Al₂(PO₄)₃.

It is particularly preferred that the lithium cobaltates employed in the invention have a spherical-like morphology as this improves packing and production characteristics. Preferably, a crystal structure of the lithium cobaltates is independently a R-3m type space group (rhombohedral, including distorted rhombohedral). In a R-3m type space group, the lithium ion occupies the “3a” site (x=0, y=0 and z=0) and the transition metal ion (i.e., Co in a lithium cobaltate) occupies the “3b” site (x=0, y=0, z=0.5). Oxygen is located in the “6a” site (x=0, y=0, z=z0, where z0 varies depending upon the nature of the metal ions, including modifier(s) thereof).

Lithium manganate spinel compounds that can be employed in the invention have a manganese base, such as LiMn₂O₄. While the manganate spinel compounds typically have low specific capacity (e.g., in a range of about 120 to 130 mAh/g), they generally have high power delivery when formulated into electrodes and are typically safe in terms of chemical reactivity at higher temperatures. Another advantage of the manganate spinel compounds is their relatively low cost.

One type of lithium manganate spinel compounds that can be employed in the invention is represented by an empirical formula of Li₍₁₊ₓ₁₎(Mn_{1-y1}A′_{y2})₂₋ₓ₂O_{z1}, wherein A′ is one or more of Mg, Al, Co, Ni and Cr; x1 and x2 are each independently equal to or greater than 0.01 and equal to or less than 0.3; y1 and y2 are each independently equal to or greater than 0.0 and equal to or less than 0.3; z1 is equal to or greater than 3.9 and equal to or less than 4.1. Preferably, A′ includes a M³⁺ ion, such as Al³⁺, Co³⁺, Ni³⁺ and Cr³⁺, more preferably Al³⁺. The lithium manganate spinel compounds of Li₍₁₊ₓ₁₎(Mn_{1-y1}A′_{y2})₂₋ₓ₂O_{z1} can have enhanced cyclability and power compared to those of LiMn₂O₄.

Another type of lithium manganate spinel compounds that can be used in the invention is represented by an empirical formula of Li₍₁₊ₓ₁₎Mn₂O_{z1}, wherein x1 is equal to or greater than zero and equal to or less than 0.3, and z1 is equal to or greater than 3.9 and equal to or less than 4.2. In a specific embodiment, x1 is equal to or greater than 0.01 and equal to or less than 0.3. In another specific embodiment, x1 is equal to or greater than 0.01 and equal to or less than 0.2. In yet another specific embodiment, x1 is equal to or greater than 0.05 and equal to or less than 0.15.

A specific example of the lithium manganate spinel compounds that can be employed in the invention is represented by an empirical formula of Li₍₁₊ₓ₁₎(Mn_{1-y1}A′_{y2})₂₋ₓ₂O_{z1}, wherein y1 and y2 are each independently greater than 0.0 and equal to or less than 0.3, and the other values are the same as described above for Li₍₁₊ₓ₁₎(Mn_{1-y1}A′_{y2})₂₋ₓ₂O_{z1}. Other specific examples of the lithium manganate spinel compounds that can be employed in the invention include LiMn_{1.9}Al_{0.1}O₄, Li₁₊ₓ₁Mn₂O₄, and their variations with Al and Mg modifiers. Various other examples of lithium manganate spinel compounds of the type Li₍₁₊ₓ₁₎(Mn_{1-y1}A′_{y2})₂₋ₓ₂O_{z1} can be found in U.S. Pat. Nos. 4,366,215; 5,196,270; and 5,316,877 (the entire teachings of which are incorporated herein by reference).

The active cathode materials of the invention can be prepared by mixing the lithium cobaltate and the lithium manganate spinel compound, preferably in a powdered form.

Another aspect of the present invention is directed to a lithium-ion battery (or cell) that employs an active cathode material of the invention described above. Preferably, the battery has a greater than about 2.2 Ah/cell capacity. More preferably, the battery has a greater than about 3.0 Ah/cell capacity, such as equal to or greater than about 3.3 Ah/cell; equal to or greater than about 3.5 Ah/cell; equal to or greater than about 3.8 Ah/cell; equal to or greater than about 4.0 Ah/cell; equal to or greater than about 4.2 Ah/cell; between about 3.0 Ah/cell and about 6 Ah/cell; between about 3.3 Ah/cell and about 6 Ah/cell; between about 3.3 Ah/cell and about 5 Ah/cell; between about 3.5 Ah/cell and about 5 Ah/cell; between about 3.8 Ah/cell and about 5 Ah/cell; or between about 4.0 Ah/cell and about 5 Ah/cell.

The battery (or cell) of the invention can be cylindrical (e.g., 26650, 18650, or 14500 configuration) or prismatic (stacked or wound, e.g., 183665 or 103450 configuration). Preferably, they are prismatic, and, more preferably, of a prismatic shape that is oblong. Although the present invention can use all types of prismatic cell casings, an oblong cell casing is preferred partly due to the two features described below.

The available internal volume of an oblong shape, such as the 183665 form factor, is larger than the volume of two 18650 cells, when comparing stacks of the same external volume. When assembled into a battery pack, the oblong cell fully utilizes more of the space that is occupied by the battery pack. This enables novel design changes to the internal cell components that can increase key performance features without sacrificing cell capacity relative to that found in the industry today. Due to the larger available volume, one can elect to use thinner electrodes, which have relatively higher cycle life and a higher rate capability. Furthermore, an oblong can has larger flexibility. For instance, an oblong shape can flex more at the waist point compared to a cylindrically shaped can, which allows less flexibility as stack pressure increases upon charging. The increased flexibility decreases mechanical fatigue on the electrodes, which, in turn, causes higher cycle life. Also, clogging of pores of a separator in batteries can be improved by employing a relatively low stack pressure.

A particularly desired feature, allowing relatively higher safety, is available for the oblong shaped battery compared to the prismatic battery. The oblong shape provides a snug fit to the jelly roll, which minimizes the amount of electrolyte necessary for the battery. The relatively low amount of electrolyte results in less available reactive material during a misuse scenario and hence higher safety. In addition, the cost is lower due to employment of a lower amount of electrolyte. In the case of a prismatic can with a stacked electrode structure, whose cross-section is in a rectangular shape, essentially full volume utilization is possible without unnecessary electrolyte, but this type of can design is more difficult and hence more costly from a manufacturing point-of-view.

In one specific embodiment, cell building for a battery (or cell) of the invention utilizes a larger format in terms of Ah/cell than that is currently used in the industry, such as in the case for 18650 cells (e.g., cylindrical cells). In one specific embodiment, a battery (or cell) of the invention has an 183665 form factor (e.g., prismatic cell). For example, the battery (or cell) of the invention has an oblong shape with a thickness of about 17 mm or about 18 mm, a width of about 44 mm or about 36 mm, a height of about 64 mm or about 65 mm. In some specific embodiments, a battery (or cell) has a thickness of about 17 mm, a width of about 44 mm and a height of about 64 mm; a thickness of about 18 mm, a width of about 36 mm and a height of about 65 mm; or a thickness of about 18 mm, a width of about 27 mm and a height of about 65 mm.

Alternatively, in another specific embodiment, a battery (or cell) of the invention has an 1865 form factor as in an 18650 cell.

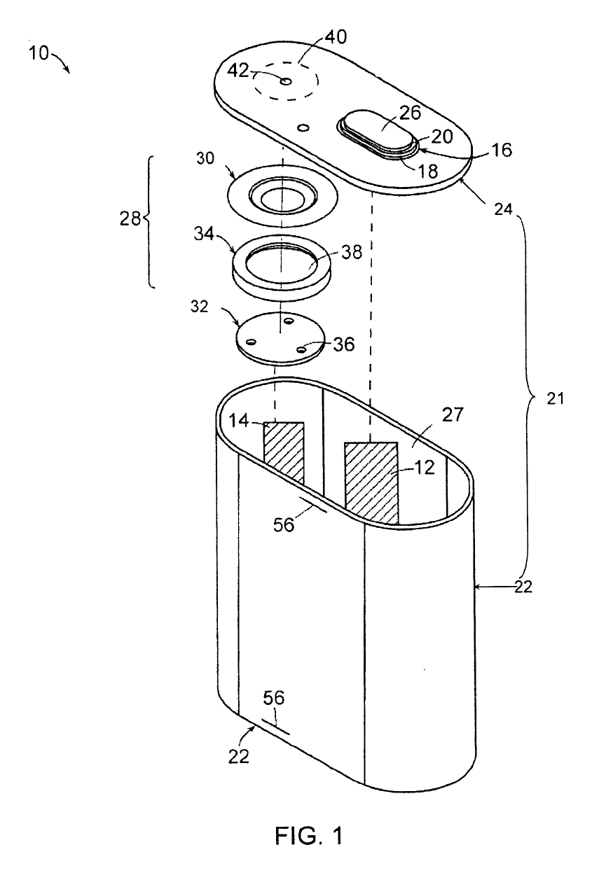

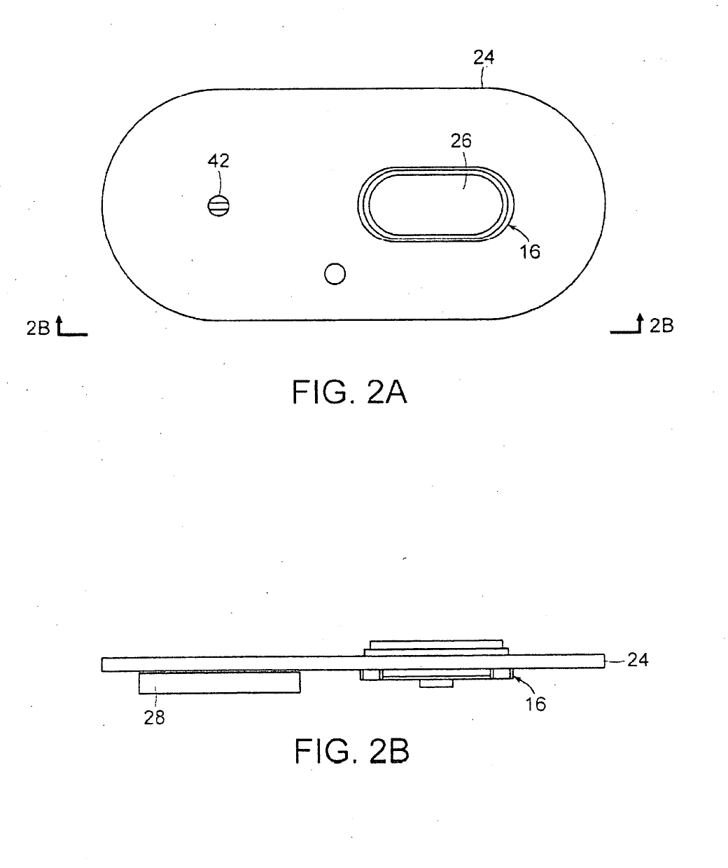

FIG. 1 shows one specific embodiment, battery 10, of the invention, wherein battery 10 has an oblong cross-sectional shape. FIGS. 2A and 2B show a top view and cross-sectional view of the lid of battery 10 of FIG. 1, respectively. As shown in FIG. 1, battery 10 includes first electrode 12 and second electrode 14. First electrode 12 is electrically connected to feed-through device 16, which includes first component 18, which is proximal to first electrode 12, and second component 20, which is distal to first electrode 12. Feed-through device 16 can further include conductive layer 26. The electrodes 12 and 14 are placed inside battery can 21 that includes cell casing 22 and lid 24, i.e., internal space 27 defined by cell casing 22 and lid 24. Cell casing 22 and lid 24 of battery 10 are in electrical communication with each other.

Battery 10 of the invention can optionally include current interrupt device (CID) 28, as shown in FIG. 1. CID 28 can be activated at an internal gauge pressure in a range of, for example, between about 4 kg/cm² and about 15 kg/cm² (e.g., between about 4 kg/cm² and about 10 kg/cm², between about 4 kg/cm² and about 9 kg/cm², between about 5 kg/cm² and about 9 kg/cm² or between 7 kg/cm² and about 9 kg/cm²). As used herein, “activation” of the CID means that current flow of an electronic device through the CID is interrupted. In a specific embodiment, the CID of the invention includes a fist conductive component and a second conductive component in electrical communication with each other (e.g., by welding, crimping, riveting, etc.). In this CID, “activation” of the CID means that the electrical communication between the first and second conductive components is interrupted. The first and second components of the CID can be in any suitable form, such as a plate or disk.

CID 28 typically includes first conductive component 30 and second conductive component 32 in electrical communication with each other (e.g., by welding, crimping, riveting, etc.). Second conductive component 32 is in electrical communication with second electrode 14, and first conductive component 30 is in electrical contact with battery can 21, for example, lid 24. Battery can 21, i.e., cell casing 22 and lid 24, is electrically insulated from a first terminal of battery 10 (e.g., electrically conductive layer 26), and at least a portion of battery can 21 is at least a component of a second terminal of battery 10, or is electrically connected to the second terminal. In one specific embodiment, at least a portion of lid 24 or the bottom of cell casing 22 serves as the second terminal of battery 10, and conductive layer 26 serves as the first terminal of battery 10. In a specific embodiment, first conductive component 30 includes a cone- or dome-shaped part. In another specific embodiment, at least a portion of the top (or cap) of the cone- or dome-shaped part is essentially planar. In yet another specific embodiment, first and second conductive components 30 and 32 of CID 28 are in direct contact with each other at a portion of the essentially planar cap. In yet another specific embodiment, first conductive component 30 includes a frustum having an essentially planar cap, as described in U.S. Provisional Application No. 60/936,825, filed on Jun. 22, 2007 (the entire teachings of which are incorporated herein by reference).

CID 28 can further include insulator 34 (e.g., insulating layer or insulating gasket) between a portion of first conductive component 30 and second conductive component 32.

In one specific embodiment, at least one of second conductive component 32 and insulator 34 of CID 28 includes at least one hole (e.g., holes 36 or 38 in FIG. 1) through which gas within battery 10 is in fluid communication with first conductive component 30.

In another specific embodiment, CID 28 further includes end component 40 disposed over first conductive component 30, and defining at least one hole 42 through which first conductive component 30 is in fluid communication with the atmosphere outside the battery. End component 40 (e.g., a plate or disk) can be a part of battery can 21, as shown in FIG. 1 where end component 40 is a part of lid 24 of battery can 21. Alternatively, end component 40 can be a separate component from battery can 21, and be placed at battery can 21, for example, over, under or at lid 24 of battery can 21.

As used herein, the “terminals” of the batteries of the invention mean the parts or surfaces of the batteries to which external electric circuits are connected.

The batteries of the invention typically include a first terminal in electrical communication with a first electrode, and a second terminal in electrical communication with a second electrode. The first and second electrodes are contained within a cell casing, for example, in a “jelly roll” form. The first terminal can be either a positive terminal in electrical communication with a positive electrode of the battery, or a negative terminal in electrical communication with a negative electrode of the battery, and vice versa for the second terminal. In one embodiment, the first terminal is a negative terminal in electrical communication with a negative electrode of the battery, and the second terminal is a positive terminal in electrical communication with a positive electrode of the battery.

As used herein, the phrase “electrically connected” or “in electrical communication” or “electrically contacted” means certain parts are in communication with each other by flow of electrons through conductors, as opposed to electrochemical communication which involves flow of ions, such as Li⁺, through electrolytes.

As used herein, the phrase “electrochemical communication” means communication between certain parts through electrolyte media and involves flows of ions, such as Li⁺.

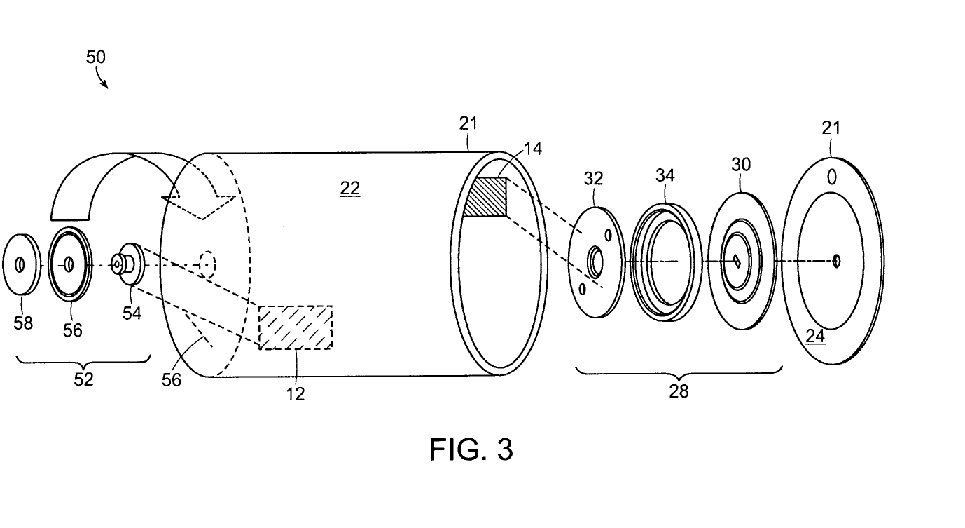

FIG. 3 shows another embodiment, battery 50, of the invention, wherein battery 50 has a cylindrical cross-sectional shape. As shown in FIG. 3, battery 50 includes battery can 21 that includes cell casing 22 and lid 24, first electrode 12 and second electrode 14, and optionally CID 28. Features, including specific features, of cell casing 22, lid 24, first electrode 12, second electrode 14 and CID 28 are as described above for battery 10 of FIGS. 1-2B. First electrode 12 is in electrical communication with a first terminal of the battery (e.g., conductive component 58), and second electrode 14 is in electrical communication with a second terminal of the battery (e.g., lid 24). Cell casing 22 and lid 24 are in electrical contact with each other. The tabs (not shown in FIG. 3) of first electrode 12 are electrically connected (e.g., by welding, crimping, riveting, etc.) to electrically-conductive, first component 54 of feed-through device 52. The tabs (not shown in FIG. 3) of second electrode 14 are in electrically connected (e.g., by welding, crimping, riveting, etc.) to second conductive component 32 of CID 28. Feed-through device 52 includes first conductive component 54, which is electrically conductive, insulator 56, and second conductive component 58, which can be the first terminal of battery 50.

In battery 50, battery can 21, i.e., cell casing 22 and lid 24, is electrically insulated from a first terminal of battery 50 (e.g., conductive component 58), and at least a portion of battery can 21 is at least a component of a second terminal of battery 50, or is electrically connected to the second terminal. In one specific embodiment, at least a portion of lid 24 or the bottom of cell casing 22 serves as the second terminal of battery 50, and conductive component 58 serves as the first terminal of battery 50.

Although FIGS. 1-3 show CID assemblies where CID 28 is in electrical communication with second electrode 14, a CID assembly where a CID, such as CID 28, is in electrical communication with first electrode 12 can also be employed in the invention.

In batteries 10 and 50 of FIGS. 1-3, first electrode 12 and second electrode 14 can be the negative and positive electrodes described above, or vice versa.

The negative electrode of a battery (or cell) of the invention can include any suitable material allowing lithium to be inserted in or removed from the material. Examples of such materials include carbonaceous materials, for example, non-graphitic carbon, artificial carbon, artificial graphite, natural graphite, pyrolytic carbons, cokes such as pitch coke, needle coke, petroleum coke, graphite, vitreous carbons, or a heat treated organic polymer compound obtained by carbonizing phenol resins, furan resins, or similar, carbon fibers, and activated carbon. Further, metallic lithium, lithium alloys, and an alloy or compound thereof are usable as the negative active materials. In particular, the metal element or semiconductor element allowed to form an alloy or compound with lithium may be a group IV metal element or semiconductor element, such as but not limited to, silicon or tin. Oxides allowing lithium to be inserted in or removed from the oxide at a relatively low potential, such as iron oxide, ruthenium oxide, molybdenum oxide, tungsten oxide, titanium oxide, and tin oxide, and nitrides can be similarly usable as the negative active materials. In a specific embodiment, amorphous tin optionally doped with a transition metal, such as cobalt or iron/nickel, is employed in the invention.

The positive electrode of a battery (or cell) of the invention includes an active cathode material of the invention described above. It is noted that the suitable cathode materials described herein are characterized by empirical formulas that exist upon manufacture of lithium-ion batteries in which they are incorporated. It is understood that their specific compositions thereafter are subject to variation pursuant to their electrochemical reactions that occur during use (e.g., charging and discharging).

In some embodiments, the positive electrode of a battery (or cell) of the invention has a packing density in a range of between about 2.6 g/cm³ and about 3.7 g/cm³. In one specific embodiment, the positive electrode of a battery (or cell) of the invention has a packing density in a range of between about 3.0 g/cm³ and about 3.7 g/cm³. In another specific embodiment, the positive electrode of a battery (or cell) of the invention has a packing density in a range of between about 3.3 g/cm³ and about 3.6 g/cm³. In yet another specific embodiment, the positive electrode of a battery (or cell) of the invention has a packing density in a range of between about 3.5 g/cm³ and about 3.6 g/cm³. The positive electrode with the aforementioned density can be made by any suitable method known in the art. For example, the cathode material is mixed with other ingredients, such as a conductive agent (e.g. acetylene black), a binder (e.g., PVDF), etc. The mixture is then dispersed in a solvent (e.g., N-methyl-2-pyrrolidone (NMP)) to form a slurry. This slurry is then applied to both surfaces of an aluminum current collector foil, and dried. The dried electrode is then pressed (e.g., calendered) by a roll press, to obtain a compressed positive electrode with the desired density.

Examples of suitable non-aqueous electrolytes include a non-aqueous electrolytic solution prepared by dissolving an electrolyte salt in a non-aqueous solvent, a solid electrolyte (inorganic electrolyte or polymer electrolyte containing an electrolyte salt), and a solid or gel-like electrolyte prepared by mixing or dissolving an electrolyte in a polymer compound or the like.

The non-aqueous electrolytic solution is typically prepared by dissolving a salt in an organic solvent. The organic solvent can include any suitable type that has been generally used for batteries of this type. Examples of such organic solvents include propylene carbonate (PC), ethylene carbonate (EC), diethyl carbonate (DEC), dimethyl carbonate (DMC), 1,2-dimethoxyethane, 1,2-diethoxyethane, γ-butyrolactone, tetrahydrofuran, 2-methyl tetrahydrofuran, 1,3-dioxolane, 4-methyl-1,3-dioxolane, diethyl ether, sulfolane, methylsulfolane, acetonitrile, propionitrile, anisole, acetate, butyrate, propionate and the like. It is preferred to use cyclic carbonates such as propylene carbonate, or chain carbonates such as dimethyl carbonate and diethyl carbonate. These organic solvents can be used singly or in a combination of two types or more.

Additives or stabilizers may also be present in the electrolyte, such as VC (vinyl carbonate), VEC (vinyl ethylene carbonate), EA (ethylene acetate), TPP (triphenylphosphate), phosphazenes, biphenyl (BP), cyclohexylbenzene (CHB), 2,2-diphenylpropane (DP), lithium bis(oxalato)borate (LiBoB), ethylene sulfate (ES) and propylene sulfate. These additives are used as anode and cathode stabilizers, flame retardants or gas releasing agents, which may make a battery have higher performance in terms of formation, cycle efficiency, safety and battery life.

The solid electrolyte can include an inorganic electrolyte, a polymer electrolyte and the like insofar as the material has lithium-ion conductivity. The inorganic electrolyte can include, for example, lithium nitride, lithium iodide and the like. The polymer electrolyte is composed of an electrolyte salt and a polymer compound in which the electrolyte salt is dissolved. Examples of the polymer compounds used for the polymer electrolyte include ether-based polymers such as polyethylene oxide and cross-linked polyethylene oxide, polymethacrylate ester-based polymers, acrylate-based polymers and the like. These polymers may be used singly, or in the form of a mixture or a copolymer of two kinds or more.

A matrix of the gel electrolyte may be any polymer insofar as the polymer is gelated by absorbing the above-described non-aqueous electrolytic solution. Examples of the polymers used for the gel electrolyte include fluorocarbon polymers such as polyvinylidene fluoride (PVDF), polyvinylidene-co-hexafluoropropylene (PVDF-HFP) and the like.

Examples of the polymers used for the gel electrolyte also include polyacrylonitrile and a copolymer of polyacrylonitrile. Examples of monomers (vinyl based monomers) used for copolymerization include vinyl acetate, methyl methacrylate, butyl methacylate, methyl acrylate, butyl acrylate, itaconic acid, hydrogenated methyl acrylate, hydrogenated ethyl acrylate, acrlyamide, vinyl chloride, vinylidene fluoride, and vinylidene chloride. Examples of the polymers used for the gel electrolyte further include acrylonitrile-butadiene copolymer rubber, acrylonitrile-butadiene-styrene copolymer resin, acrylonitrile-chlorinated polyethylene-propylenediene-styrene copolymer resin, acrylonitrile-vinyl chloride copolymer resin, acrylonitrile-methacylate resin, and acrlylonitrile-acrylate copolymer resin.

Examples of the polymers used for the gel electrolyte include ether based polymers such as polyethylene oxide, copolymer of polyethylene oxide, and cross-linked polyethylene oxide. Examples of monomers used for copolymerization include polypropylene oxide, methyl methacrylate, butyl methacylate, methyl acrylate, butyl acrylate.

In particular, from the viewpoint of oxidation-reduction stability, a fluorocarbon polymer is preferably used for the matrix of the gel electrolyte.

The electrolyte salt used in the electrolyte may be any electrolyte salt suitable for batteries of this type. Examples of the electrolyte salts include LiClO₄, LiAsF₆, LiPF₆, LiBF₄, LiB(C₆H₅)₄, LiB(C₂O₄)₂, CH₃SO₃Li, CF₃SO₃Li, LiCl, LiBr and the like. Generally, a separator separates the positive electrode from the negative electrode of the batteries. The separator can include any film-like material having been generally used for forming separators of non-aqueous electrolyte secondary batteries of this type, for example, a microporous polymer film made from polypropylene, polyethylene, or a layered combination of the two. In addition, if a solid electrolyte or gel electrolyte is used as the electrolyte of the battery, the separator does not necessarily need to be provided. A microporous separator made of glass fiber or cellulose material can in certain cases also be used. Separator thickness is typically between about 9 microns and about 25 microns.

In one specific embodiment, an electrolyte containing for instance PC, EC, DMC, DEC solvents with 1M LiPF₆ and suitable additives at 0.5-3 wt. % each, such as VC, LiBOB, PF, LiTFSI or BP, is vacuum filled in battery can 21 (see FIGS. 1 and 3) having the spirally wound “jelly roll”.

In one specific embodiment, the positive electrode of a battery (or cell) of the invention is produced by mixing the cathode material at about 94 wt % together with about 3 wt % of a conductive agent (e.g. acetylene black), and about 3 wt % of a binder (e.g., PVDF). The mix is then dispersed in a solvent (e.g., N-methyl-2-pyrrolidone (NMP)), in order to prepare a slurry. This slurry is then applied to both surfaces of an aluminum current collector foil, which typically has a thickness of about 20 um, and dried at about 100-150° C. The dried electrode is then calendered by a roll press, to obtain the compressed positive electrode.

In another specific embodiment of a battery (or cell) of the invention, the negative electrode is prepared by mixing about 93 wt % of graphite as a negative active material, about 3 wt % of conductive carbon (e.g. acetylene black), and about 4 wt % of a binder (e.g. PVDF). The negative electrode is then prepared from this mix in a process similar to that described above for positive electrode except that a copper current collector foil, typically of about 10-15 μm thickness, is used.

In yet another specific embodiment of a battery (or cell) of the invention, the positive electrode is produced by mixing the cathode powders at a specific ratio. About 90 wt % of this blend is then mixed together with about 5 wt % of acetylene black as a conductive agent, and about 5 wt % of PVDF as a binder. The mix is dispersed in N-methyl-2-pyrrolidone (NMP) as a solvent, in order to prepare slurry. This slurry is then applied to both surfaces of an aluminum current collector foil, having a typical thickness of about 20 μm, and dried at about 100-150° C. The dried electrode is then calendared by a roll press, to obtain a compressed positive electrode. When LiCoO₂ is solely used as the positive electrode a mixture using about 94 wt % LiCoO₂, about 3% acetylene black, and about 3% PVDF is typically used. In this embodiment, the negative electrode can be prepared by mixing about 93 Wt % of graphite as a negative active material, about 3 wt % acetylene black, and about 4 wt % of PVDF as a binder. The negative mix is also dispersed in N-methyl-2-pyrrolidone as a solvent, in order to prepare the slurry. The negative mix slurry was uniformly applied on both surfaces of a strip-like copper negative current collector foil, having a typical thickness of about 10 μm. The dried electrode is then calendared by a roll press to obtain a dense negative electrode.

The negative and positive electrodes, and a separator (e.g., about 25 microns thick) formed of, for example, a polyethylene film with micro pores are generally laminated and spirally wound to produce a spiral type electrode element.

In some embodiments, one or more positive lead current carrying tabs are attached to the positive electrode and welded to feed-through device 16 (see FIGS. 1 and 3). A negative lead, made of nickel metal, connects the negative electrode to the bottom or the lid of battery can 21 (see FIGS. 1 and 3).

Referring back to FIGS. 1-3, the term “feed-through” includes any material or device that connects electrode 12, within the internal space defined by cell casing 22 and lid 24, with a component of the battery external to that defined internal space. In one specific embodiment, feed-through device 16 or 52 extends through a pass-through hole defined by lid 24. Feed-through device 16 or 52 also can pass through lid 24 without deformation, such as bending, twisting and/or folding, and can increase cell capacity. Any other suitable means known in the art can also be used in the invention to connect electrode 12 with a component of the battery external to battery can 21, e.g., a terminal of the battery. Generally, feed-through devices 16 and 52 are electrically insulated from battery can 21, for example, lid 24, for example, by an insulating gasket (not shown in FIGS. 1-2B, insulator 56 of FIG. 3). The insulating gasket is formed of a suitable insulating material, such as polypropylene, polyvinylfluoride (PVF), etc. Components 18, 20 and 26 of feed-through device 16, and components 54 and 58 of feed-through device 52 can be made of any suitable conductive material known in the art, for example, nickel.

Referring back to FIGS. 1 and 3, in a specific embodiment, when first conductive component 30 separates from second conductive component 32, no rupture occurs in first conductive component 30 so that gas inside battery 10 or 50 does not go out through first conductive component 30. The gas can exit battery 10 or 50 through one or more venting means 56 (e.g., at cell wall or the bottom part of cell casing 22, or first conductive component 30), when the internal pressure keeps increasing and reaches a predetermined value for activation of venting means 56. In some embodiments, the predetermined gauge pressure value for activation of venting means 56 (e.g., between about 10 kg/cm² and about 20 kg/cm²) is higher than that for activation of CID 28 (e.g., between about 5 kg/cm² and about 10 kg/cm²). This feature helps prevent premature gas leakage, which can damage neighboring batteries (or cells) which are operating normally. So, when one of a plurality of cells in the battery packs of the invention is damaged, the other healthy cells are not damaged. It is noted that gauge pressure values or sub-ranges suitable for the activation of CID 28 and those for activation of venting means 56 are selected from among the predetermined gauge pressure ranges such that there is no overlap between the selected pressure values or sub-ranges. Preferably, the values or ranges of gauge pressure for the activation of CID 28 and those for the activation of venting means 56 differ by at least about 2 kg/cm² pressure difference, more preferably by at least about 4 kg/cm², even more preferably by at least about 6 kg/cm², such as by about 7 kg/cm².

First conductive component 30, second conductive component 32 and end component 40 of CID 28 can be made of any suitable conductive material known in the art for a battery. Examples of suitable materials include aluminum, nickel and copper, preferably aluminum. In one specific embodiment, battery can 21 (e.g., cell casing 22 and lid 24), first conductive component 30 and second conductive component 32 are made of substantially the same metals. As used herein, the term “substantially same metals” means metals that have substantially the same chemical and electrochemical stability at a given voltage, e.g., the operation voltage of a battery. More preferably, battery can 21, first conductive component 30 and second conductive component 32 are made of the same metal, such as aluminum (e.g., Aluminum 3003 series, such as Aluminum 3003H-14 series and/or Aluminum 3003H-0 series).

CID 28 can be made by any suitable method known in the art, for example, in WO 2008/002487 and U.S. Provisional Application No. 60/936,825 (the entire teachings of both of which are incorporated herein by reference). Attachment of CID 28 to battery can 21 can be done by any suitable means known in the art. In a specific embodiment, CID 28 is attached to battery can 21 via welding, and more preferably by welding first conductive component 30 onto end component 40 (or lid 24 itself).

Cell casing 22 can be made of any suitable electrically-conductive material which is essentially stable electrically and chemically at a given voltage of batteries, such as the lithium-ion batteries of the invention. Examples of suitable materials of cell casing 22 include metallic materials, such as aluminum, nickel, copper, steel, nickel-plated iron, stainless steel and combinations thereof. In a specific embodiment, cell casing 22 is of, or includes, aluminum.

Examples of suitable materials of lid 24 are the same as those listed for cell casing 22. In a specific embodiment, lid 24 is made of the same material as cell casing 22. In another specific embodiment, both cell casing 22 and lid 24 are formed of, or include, aluminum.

Lid 24 can hermetically seal cell casing 22 by any suitable method known in the art (e.g., welding, crimping, etc). In a specific embodiment, lid 24 and cell casing 22 are welded to each other. In another specific embodiment, the weld connecting lid 24 and cell casing 22 ruptures when an gauge pressure between lid 24 and cell casing 22 is greater than about 20 kg/cm².

Referring back to FIGS. 1 and 3, in some preferred embodiments, cell casing 22 includes at least one venting means 56 as a means for venting interior gaseous species when necessary (e.g., when an internal gauge pressure is in a range of between about 10 kg/cm² and about 20 kg/cm², such as between about 12 kg/cm² and about 20 kg/cm² or between about 10 kg/cm² and about 18 kg/cm²). It is to be understood that any suitable type of venting means can be employed as long as the means provide hermetic sealing in normal battery operation conditions. Various suitable examples of venting means are described in U.S. Provisional Application No. 60/717,898, filed on Sep. 16, 2005, the entire teachings of which are incorporated herein by reference.

Specific examples of venting means include vent scores. As used herein, the term “score” means partial incision of section(s) of a cell casing, such as cell casing 104, that is designed to allow the cell pressure and any internal cell components to be released at a defined internal pressure. Preferably, venting means 112 is a vent score, more preferably, vent score that is directionally positioned away from a user/or neighboring cells. More than one vent score can be employed in the invention. In some embodiments, patterned vent scores can be employed. The vent scores can be parallel, perpendicular, diagonal to a major stretching (or drawing) direction of the cell casing material during creation of the shape of the cell casing. Consideration is also given to vent score properties, such as depth, shape and length (size).

The batteries of the invention can further include a positive thermal coefficient layer (PTC) in electrical communication with either the first terminal or the second terminal, preferably in electrical communication with the first terminal. Suitable PTC materials are those known in the art. Generally, suitable PTC materials are those that, when exposed to an electrical current in excess of a design threshold, its electrical conductivity decreases with increasing temperature by several orders of magnitude (e.g., 10⁴ to 10⁶ or more). Once the electrical current is reduced below a suitable threshold, in general, the PTC material substantially returns to the initial electrical resistivity. In one suitable embodiment, the PTC material includes small quantities of semiconductor material in a polycrystalline ceramic, or a slice of plastic or polymer with carbon grains embedded in it. When the temperature of the PTC material reaches a critical point, the semiconductor material or the plastic or polymer with embedded carbon grains forms a barrier to the flow of electricity and causes electrical resistance to increase precipitously. The temperature at which electrical resistivity precipitously increases can be varied by adjusting the composition of the PTC material, as is known in the art. An “operating temperature” of the PTC material is a temperature at which the PTC exhibits an electrical resistivity about half way between its highest and lowest electrical resistance. Preferably, the operating temperature of the PTC layer employed in the invention is between about 70° Celsius and about 150° Celsius.

Examples of specific PTC materials include polycrystalline ceramics containing small quantities of barium titanate (BaTiO₃), and polyolefins including carbon grains embedded therein. Examples of commercially available PTC laminates that include a PTC layer sandwiched between two conducting metal layers include LTP and LR4 series manufactured by Raychem Co. Generally, the PTC layer has a thickness in a range of about 50 μm and about 300 μm.

Preferably, the PTC layer includes an electrically conductive surface, the total area of which is at least about 25% or at least about 50% (e.g., about 48% or about 56%) of the total surface area of lid 24 or the bottom of battery 10 or 50. The total surface area of the electrically conductive surface of the PTC layer can be at least about 56% of the total surface area of lid 24 or the bottom of battery 10 or 50. Up to 100% of the total surface area of lid 24 of battery 10 or 50 can occupied by the electrically conductive surface of the PTC layer. Alternatively, the whole, or part, of the bottom of battery 10 or 50 can be occupied by the electrically conductive surface of the PTC layer.

The PTC layer can be positioned externally to the battery can, for example, over a lid (e.g., lid 24 of FIGS. 1 and 3) of the battery can.

In one specific embodiment, the PTC layer is between a first conductive layer and a second conductive layer and at least a portion of the second conductive layer is at least a component of the first terminal, or is electrically connected to the first terminal. In another specific embodiment, the first conductive layer is connected to the feed-through device. Suitable examples of such a PTC layer sandwiched between the first and second conductive layers are described in WO 2007/149102, the entire teachings of which are incorporated herein by reference.

In some specific embodiments, a battery of the invention includes battery can 21 that includes cell casing 22 and lid 24, at least one CID, such as CID 28 described above, in electrical communication with either of the first or second electrodes of the battery, and at least one venting means 56 on cell casing 22. As described above, battery can 21 is electrically insulated from the first terminal that is in electrical communication with the first electrode of the battery. At least a portion of battery can 21 is at least a component of the second terminal that is in electrical communication with the second electrode of the battery. Lid 24 is welded on cell casing 22 such that the welded lid is detached from cell casing 22 at an internal gauge pressure greater than about 20 kg/cm². The CID includes a first conductive component (e.g., first conductive component 30) and a second conductive component (e.g., second conductive component 32) in electrical communication with each other, preferably by a weld. This electrical communication is interrupted at an internal gauge pressure between about 4 kg/cm² and about 10 kg/cm², (e.g., between about 5 kg/cm² and about 9 kg/cm² or between about 7 kg/cm² and about 9 kg/cm²). For example, the first and second conductive components are welded, e.g., laser welded, to each other such that the weld ruptures at the predetermined gauge pressure. At least one venting means 56 is formed to vent interior gaseous species when an internal gauge pressure in a range of between about 10 kg/cm² and about 20 kg/cm² or between about 12 kg/cm² and about 20 kg/cm². As described above, it is noted that gauge pressure values or sub-ranges suitable for the activation of CID 28 and those for activation of venting means 56 are selected from among the predetermined gauge pressure ranges such that there is no overlap between the selected pressure values or sub-ranges. Typically, the values or ranges of gauge pressure for the activation of CID 28 and those for the activation of venting means 56 differ by at least about 2 kg/cm² pressure difference, more typically by at least about 4 kg/cm², even more preferably by at least about 6 kg/cm², such as by about 7 kg/cm². Also, it is noted that gauge pressure values or sub-ranges suitable for the rupture of the welded lid 24 from cell casing 22 and those for activation of venting means 56 are selected from among the predetermined gauge pressure ranges such that there is no overlap between the selected pressure values or sub-ranges.

Generally, the battery of the invention is rechargeable. In a specific embodiment, the battery of the invention is a rechargeable lithium-ion battery.

In a certain embodiment, the battery of the invention, such as a lithium-ion battery, has an internal gauge pressure of less than or equal to about 2 kg/cm² under a normal working condition. For such a battery of the invention, the active electrode materials can be first activated prior to hermetical sealing of the battery can.

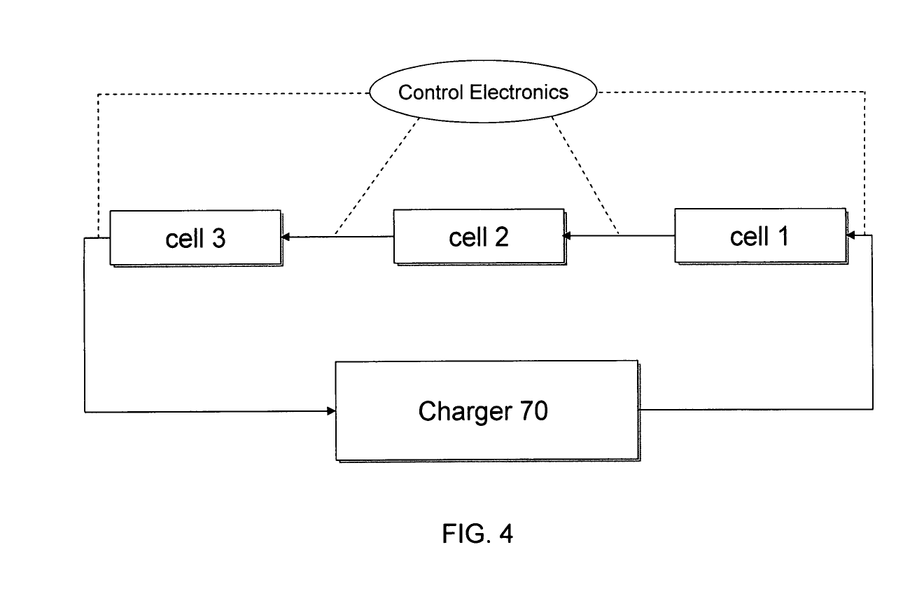

FIG. 4 is a schematic circuitry of the invention, showing how individual cells or batteries (e.g., battery 10 of FIG. 1 or battery 50 of FIG. 3) are arranged together in a battery pack. Charger 70 is employed to charge cells 1, 2 and 3.

As shown in FIG. 4, in some embodiments of the invention, a plurality of lithium-ion batteries of the invention (e.g., 2 to 5 cells) can be connected in a battery pack, wherein each of the batteries (cells) is connected with each other in series, parallel, or in series and parallel. In some battery packs of the invention, there are no parallel connections between the batteries.

Preferably, at least one cell has a prismatic shaped cell casing, and more preferably, an oblong shaped cell casing, as shown in FIG. 1. Preferably, the capacity of the cells in the battery pack is typically equal to or greater than about 3.0 Ah, more preferably equal to or greater than about 4.0 Ah. The internal impedance of the cells is preferably less than about 50 milli-ohms, and more preferably less than 30 milli-ohms.

The present invention also includes a method of producing a lithium-ion battery, such as a rechargeable lithium-ion battery, of the invention as described above. The method includes forming an active cathode material of the invention described above. A positive electrode is formed with the active cathode material, and a negative electrode in electrical contact with the positive electrode via an electrolyte is formed, as described above, thereby forming the lithium-ion battery.

In yet another aspect, the present invention also includes a system that includes a portable electronic device and a cell or battery (e.g., lithium-ion battery), and battery pack as described above. Examples of the portable electronic devices include portable computers, power tools, toys, portable phones, camcorders, PDAs and hybrid-electric vehicles. In one embodiment, the system includes a battery pack of the invention. Features of the battery pack are as described above.

### INCORPORATION BY REFERENCE

WO 2006/071972; WO 2007/011661; WO 2007/149102; WO 2008/002486; WO 2008/002487; U.S. Provisional Application No. 60/717,898, filed on Sep. 16, 2005; U.S. Provisional Application No. 60/936,825, filed on Jun. 22, 2007; U.S. Provisional Application, filed on the same date as the present application under Attorney's Docket No. 3853.1018-000, entitled “Battery With Enhanced Safety”; and U.S. Provisional Application, filed on the same date as the present application under Attorney's Docket No. 3853.1022-000, entitled “Prismatic Storage Battery or Cell with Flexible Recessed Portion,” are all incorporated herein by reference in their entirety.

### EQUIVALENTS

While this invention has been particularly shown and described with references to preferred embodiments thereof, it will be understood by those skilled in the art that various changes in form and details may be made therein without departing from the scope of the invention encompassed by the appended claims.

1. A lithium-ion battery having a cathode that includes an active cathode material, the active cathode material comprising a cathode mixture that includes a lithium cobaltate and a spinel type lithium manganate, wherein the lithium cobaltate and the lithium manganate are in a weight ratio of lithium cobaltate:lithium manganate between about 0.95:0.05 and about 0.55:0.45, and wherein a ratio of the mean particle diameter of the lithium cobaltate to the mean particle diameter of the lithium manganate is in a range of between about 1:0.35 and about 1:1.4.

2. The lithium-ion battery of claim 1, wherein the cathode material includes a lithium cobaltate represented by an empirical formula of
Liₓ₆M′_{y6}Co_{(1-z6)}M″_{z6}O₂ where:
x6 is greater than 0 and less than 1.2;
y6 is greater than 0 and less than 0.1;
z6 is equal to or greater than 0 and less than 0.5;
M′ is at least one of magnesium (Mg) and sodium (Na) and
M″ is at least one member of the group consisting of manganese, aluminum, boron, titanium, magnesium, calcium and strontium.

3. The lithium-ion battery of claim 2, wherein at least one of M′ and M″ is magnesium.

4. The lithium-ion battery of claim 2, wherein the lithium manganate is represented by an empirical formula of
Li₍₁₊ₓ₁₎(Mn_{1-y1}A′_{y2})₂₋ₓ₂O_{z1} where:
x1 and x2 are each independently equal to or greater than 0.01 and equal to or less than 0.3;
y1 and y2 are each independently are equal to or greater than 0.0 and equal to or less than 0.3;
z1 is equal to or greater than 3.9 and equal to or less than 4.1; and
A′ is at least one member of the group consisting of magnesium, aluminum, cobalt, nickel and chromium.

5. The lithium-ion battery of claim 4, wherein the lithium manganate is Li_{1.1}Mn_{1.96}Mg_{0.03}O₄.

6. The lithium-ion battery of claim 2, wherein the lithium manganate is represented by an empirical formula of Li₍₁₊ₓ₁₎Mn₂O_{z1}, wherein:
x1 is equal to or greater than zero and equal to or less than 0.3; and
z1 is equal to or greater than 3.9 and equal to or less than 4.2.

7. The lithium-ion battery of claim 6, wherein x1 is equal to or greater than 0.01 and equal to or less than 0.3.

8. The lithium-ion battery of claim 1, wherein the lithium cobaltate is Li₍₁₊ₓ₈₎CoO_{z8}, wherein x8 is equal to or greater than zero and equal to or less than 0.2, and wherein z8 is equal to or greater than 1.9 and equal to or less than 2.1.

9. The lithium-ion battery of claim 8, wherein the lithium manganate is represented by an empirical formula of
Li₍₁₊ₓ₁₎(Mn_{1-y1}A′_{y2})₂₋ₓ₂O_{z1} where:
x1 and x2 are each independently equal to or greater than 0.01 and equal to or less than 0.3;
y1 and y2 are each independently are equal to or greater than 0.0 and equal to or less than 0.3;
z1 is equal to or greater than 3.9 and equal to or less than 4.1; and
A′ is at least one member of the group consisting of magnesium, aluminum, cobalt, nickel and chromium.

10. The lithium-ion battery of claim 9, wherein the lithium manganate is Li_{1.1}Mn_{1.96}Mg_{0.03}O₄.

11. The lithium-ion battery of claim 9, wherein the lithium cobalate is LiCoO₂ coated with ZrO₂ or Al₂(PO₄)₃.

12. The lithium-ion battery of claim 9, wherein the lithium cobaltate is LiCoO₂.

13. The lithium-ion battery of claim 8, wherein the lithium manganate is represented by an empirical formula of Li₍₁₊ₓ₁₎Mn₂O_{z1}, wherein:
x1 is equal to or greater than zero and equal to or less than 0.3; and
z1 is equal to or greater than 3.9 and equal to or less than 4.2.

14. The lithium-ion battery of claim 13, wherein x1 is equal to or greater than 0.01 and equal to or less than 0.3.

15. The lithium-ion battery of claim 13, wherein the lithium cobalate is LiCoO₂ coated with ZrO₂ or Al₂(PO₄)₃.

16. The lithium-ion battery of claim 13, wherein the lithium cobaltate is LiCoO₂.

17. The lithium-ion battery of claim 1, wherein the lithium-ion battery has a capacity greater than about 3.0 Ah/cell.

18. The lithium-ion battery of claim 17, wherein the lithium-ion battery has a capacity greater than about 4.0 Ah/cell.

19. The lithium-ion battery of claim 1, wherein the battery has a prismatic cross-sectional shape.

20. The lithium-ion battery of claim 19, wherein the battery has an oblong cross-sectional shape.

21. The lithium-ion battery of claim 1, wherein the ratio of the mean particle diameter of the lithium cobaltate to the mean particle diameter of the lithium manganate is in a range of between about 1:0.4 and about 1:1.2.

22. The lithium-ion battery of claim 21, wherein the ratio of the mean particle diameter of the lithium cobaltate to the mean particle diameter of the lithium manganate is in a range of between about 1:0.5 and about 1:1.0.

23. The lithium-ion battery of claim 1, wherein the mean particle diameter of the lithium cobaltate is greater than the mean particle diameter of the lithium manganate.

24. The lithium-ion battery of claim 23, wherein the ratio of the mean particle diameter of the lithium cobaltate to the mean particle diameter of the lithium manganate is in a range of between about 1:0.5 and about 1:0.9.

25. The lithium-ion battery of claim 24, wherein the ratio of the mean particle diameter of the lithium cobaltate to the mean particle diameter of the lithium manganate is in a range of between about 1:0.6 and about 1:0.9.

26. The lithium-ion battery of claim 1, wherein the lithium cobaltate and manganate spinel are in a weight ratio of lithium cobaltate:manganate spinel between about 0.95:0.05 and about 0.65:0.35.

27. The lithium-ion battery of claim 26, wherein the lithium cobaltate and manganate spinel are in a weight ratio of lithium cobaltate:manganate spinel between about 0.95:0.05 and about 0.7:0.3.

28. The lithium-ion battery of claim 27, wherein the lithium cobaltate and manganate spinel are in a weight ratio of lithium cobaltate:manganate spinel between about 0.85:0.15 and about 0.75:0.25.

29. A method of forming a lithium-ion battery, comprising:
a) forming an active cathode material including a cathode mixture that includes the active cathode material comprising a cathode mixture that includes a lithium cobaltate and a spinel type lithium manganate, wherein the lithium cobaltate and the lithium manganate are in a weight ratio of lithium cobaltate:lithium manganate between about 0.95:0.05 and about 0.55:0.45, and wherein a ratio of the mean particle diameter of the lithium cobaltate to the mean particle diameter of the lithium manganate is in a range of between about 1:0.35 and about 1:1.4;
b) forming a cathode electrode with the active cathode material; and
c) forming an anode electrode in electrical contact with the cathode electrode via an electrolyte, thereby forming the lithium-ion battery.

30. The method of claim 29, wherein the cathode material includes a lithium cobaltate represented by an empirical formula of
Liₓ₆M′_{y6}Co_{(1-z6)}M″_{z6}O₂ where:
x6 is greater than 0 and less than 1.2;
y6 is greater than 0 and less than 0.1;
z6 is equal to or greater than 0 and less than 0.5;
M′ is at least one of magnesium (Mg) and sodium (Na) and
M″ is at least one member of the group consisting of manganese, aluminum, boron, titanium, magnesium, calcium and strontium.

31. The method of claim 30, wherein at least one of M′ and M″ is magnesium.

32. The method of claim 30, wherein the lithium manganate is represented by an empirical formula of
Li₍₁₊ₓ₁₎(Mn_{1-y1}A′_{y2})₂₋ₓ₂O_{z1}, where:
x1 and x2 are each independently equal to or greater than 0.01 and equal to or less than 0.3;
y1 and y2 are each independently are equal to or greater than 0.0 and equal to or less than 0.3;
z1 is equal to or greater than 3.9 and equal to or less than 4.1; and
A′ is at least one member of the group consisting of magnesium, aluminum, cobalt, nickel and chromium.

33. The method of claim 32, wherein the lithium manganate is Li_{1.1}Mn_{1.96}Mg_{0.03}O₄.

34. The method of claim 30, wherein the lithium manganate is represented by an empirical formula of Li₍₁₊ₓ₁₎Mn₂O_{z1}, wherein:
x1 is equal to or greater than zero and equal to or less than 0.3; and
z1 is equal to or greater than 3.9 and equal to or less than 4.2.

35. The method of claim 34, wherein x1 is equal to or greater than 0.01 and equal to or less than 0.3.

36. The method of claim 29, wherein the lithium cobaltate is Li₍₁₊ₓ₈₎CoO_{z8}, wherein x8 is equal to or greater than zero and equal to or less than 0.2, and wherein z8 is equal to or greater than 1.9 and equal to or less than 2.1.

37. The method of claim 36, wherein the lithium manganate is represented by an empirical formula of
Li₍₁₊ₓ₁₎(Mn_{1-y1}A′_{y2})₂₋ₓ₂O_{z1}, where:
x1 and x2 are each independently equal to or greater than 0.01 and equal to or less than 0.3;
y1 and y2 are each independently are equal to or greater than 0.0 and equal to or less than 0.3;
z1 is equal to or greater than 3.9 and equal to or less than 4.1; and
A′ is at least one member of the group consisting of magnesium, aluminum, cobalt, nickel and chromium.

38. The method of claim 37, wherein the lithium manganate is Li_{1.1}Mn_{1.96}Mg_{0.03}O₄.

39. The method of claim 37, wherein the lithium cobaltate is LiCoO₂ coated with ZrO₂ or Al₂(PO₄)₃.

40. The method of claim 37, wherein the lithium cobaltate is LiCoO₂.

41. The method of claim 36, wherein the lithium manganate is represented by an empirical formula of Li₍₁₊ₓ₁₎Mn₂O_{z1}, wherein:
x1 is equal to or greater than zero and equal to or less than 0.3; and
z1 is equal to or greater than 3.9 and equal to or less than 4.2.

42. The method of claim 41, wherein x1 is equal to or greater than 0.01 and equal to or less than 0.3.

43. The method of claim 41, wherein the lithium cobaltate is LiCoO₂ coated with ZrO₂ or Al₂(PO₄)₃.

44. The method of claim 41, wherein the lithium cobaltate is LiCoO₂.

45. The method of claim 29, wherein the lithium-ion battery has a capacity greater than about 3.0 Ah/cell.

46. The method of claim 45, wherein the lithium-ion battery has a capacity greater than about 4.0 Ah/cell.

47. The method of claim 29, wherein the battery has a prismatic cross-sectional shape.

48. The method of claim 47, wherein the battery has an oblong cross-sectional shape.

49. The method of claim 29, wherein the ratio of the mean particle diameter of the lithium cobaltate to the mean particle diameter of the lithium manganate is in a range of between about 1:0.4 and about 1:1.2.

50. The method of claim 49, wherein the ratio of the mean particle diameter of the lithium cobaltate to the mean particle diameter of the lithium manganate is in a range of between about 1:0.5 and about 1:1.0.

51. The method of claim 29, wherein the mean particle diameter of the lithium cobaltate is greater than the mean particle diameter of the lithium manganate.

52. The method of claim 51, wherein the ratio of the mean particle diameter of the lithium cobaltate to the mean particle diameter of the lithium manganate is in a range of between about 1:0.5 and about 1:0.9.

53. The method of claim 52, wherein the ratio of the mean particle diameter of the lithium cobaltate to the mean particle diameter of the lithium manganate is in a range of between about 1:0.6 and about 1:0.9.

54. The method of claim 29, wherein the lithium cobaltate and manganate spinel are in a weight ratio of lithium cobaltate:manganate spinel between about 0.95:0.05 and about 0.7:0.3.

55. The method of claim 54, wherein the lithium cobaltate and manganate spinel are in a weight ratio of lithium cobaltate:manganate spinel between about 0.85:0.15 and about 0.75:0.25.

56. A battery pack comprising a plurality of cells, wherein each of the cells includes an active cathode material including a cathode mixture that includes a lithium cobaltate and a spinel type lithium manganate, wherein the lithium cobaltate and the lithium manganate are in a weight ratio of lithium cobaltate:lithium manganate between about 0.95:0.05 to about 0.55:0.45, and wherein a ratio of the mean particle diameter of the lithium cobaltate to the mean particle diameter of the lithium manganate is in a range of between about 1:0.35 and about 1:1.4.

57. The battery pack of claim 56, wherein the cathode material includes a lithium cobaltate represented by an empirical formula of
Liₓ₆M′_{y6}Co_{(1-z6)}M″_{z6}O₂ where:
is greater than 0 and less than 1.2;
is greater than 0 and less than 0.1;
is equal to or greater than 0 and less than 0.5;
M′ is at least one of magnesium (Mg) and sodium (Na) and
M″ is at least one member of the group consisting of manganese, aluminum, boron, titanium, magnesium, calcium and strontium.

58. The battery pack of claim 57, wherein at least one of M′ and M″ is magnesium.

59. The battery pack of claim 57, wherein the lithium manganate is represented by an empirical formula of
Li₍₁₊ₓ₁₎(Mn_{1-y1}A′_{y2})₂₋ₓ₂O_{z1} where:
x1 and x2 are each independently are equal to or greater than 0.01 and equal to or less than 0.3;
y1 and y2 are each independently are equal to or greater than 0.0 and equal to or less than 0.3;
z1 is equal to or greater than 3.9 and equal to or less than 4.1; and
A′ is at least one member of the group consisting of magnesium, aluminum, cobalt, nickel and chromium.

60. The battery pack of claim 59, wherein the lithium manganate is Li_{1.1}Mn_{1.96}Mg_{0.03}O₄.

61. The battery pack of claim 57, wherein the lithium manganate is represented by an empirical formula of Li₍₁₊ₓ₁₎Mn₂O_{z1}, wherein:
x1 is equal to or greater than zero and equal to or less than 0.3; and
z1 is equal to or greater than 3.9 and equal to or less than 4.2.

62. The battery pack of claim 61, wherein x1 is equal to or greater than 0.01 and equal to or less than 0.3.

63. The battery pack of claim 56, wherein the lithium cobaltate is Li₍₁₊ₓ₈₎CoO_{z8}, wherein x8 is equal to or greater than zero and equal to or less than 0.2, and wherein z8 is equal to or greater than 1.9 and equal to or less than 2.1.

64. The battery pack of claim 63, wherein the lithium manganate is represented by an empirical formula of
Li₍₁₊ₓ₁₎(Mn_{1-y1}A′_{y2})₂₋ₓ₂O_{z1} where:
x1 and x2 are each independently equal to or greater than 0.01 and equal to or less than 0.3;
y1 and y2 are each independently are equal to or greater than 0.0 and equal to or less than 0.3;
z1 is equal to or greater than 3.9 and equal to or less than 4.1; and
A′ is at least one member of the group consisting of magnesium, aluminum, cobalt, nickel and chromium.

65. The battery pack of claim 64, wherein the lithium manganate is Li_{1.1}Mn_{1.96}Mg_{0.03}O₄.

66. The battery pack of claim 64, wherein the lithium cobaltate is LiCoO₂ coated with ZrO₂ or Al₂(PO₄)₃.

67. The battery pack of claim 64, wherein the lithium cobaltate is LiCoO₂.

68. The battery pack of claim 63, wherein the lithium manganate is represented by an empirical formula of Li₍₁₊ₓ₁₎Mn₂O_{z1}, wherein:
x1 is equal to or greater than zero and equal to or less than 0.3; and
z1 is equal to or greater than 3.9 and equal to or less than 4.2.

69. The battery pack of claim 68, wherein x1 is equal to or greater than 0.01 and equal to or less than 0.3.

70. The battery pack of claim 68, wherein the lithium cobaltate is LiCoO₂ coated with ZrO₂ or Al₂(PO₄)₃.

71. The battery pack of claim 68, wherein the lithium cobaltate is LiCoO₂.

72. The battery pack of claim 56, wherein each cell has a capacity greater than about 3.0 Ah/cell.

73. The battery pack of claim 72, wherein each cell has a capacity greater than about 4.0 Ah/cell.

74. The battery pack of claim 56, wherein each cell has a prismatic cross-sectional shape.

75. The battery pack of claim 74, wherein each cell has an oblong cross-sectional shape.

76. The battery pack of claim 56, wherein a ratio of the mean particle diameter of the lithium cobaltate to the mean particle diameter of the lithium manganate is in a range of between about 1:0.4 and about 1:1.2.

77. The battery pack of claim 76, wherein a ratio of the mean particle diameter of the lithium cobaltate to the mean particle diameter of the lithium manganate is in a range of between about 1:0.5 and about 1:1.0.

78. The battery pack of claim 56, wherein the mean particle diameter of the lithium cobaltate is greater than the mean particle diameter of the lithium manganate.

79. The battery pack of claim 78, wherein a ratio of the mean particle diameter of the lithium cobaltate to the mean particle diameter of the lithium manganate is in a range of between about 1:0.5 and about 1:0.9.

80. The battery pack of claim 79, wherein a ratio of the mean particle diameter of the lithium cobaltate to the mean particle diameter of the lithium manganate is in a range of between about 1:0.6 and about 1:0.9.

81. The battery pack of claim 56, wherein the lithium cobaltate and manganate spinel are in a weight ratio of lithium cobaltate:manganate spinel between about 0.95:0.05 and about 0.7:0.3.

82. The battery pack of claim 81, wherein the lithium cobaltate and manganate spinel are in a weight ratio of lithium cobaltate:manganate spinel between about 0.85:0.15 and about 0.75:0.25.
